(19) United States
(12) Patent Application Publication
(10) Pub. No.: US 2010/0032966 A1
(43) Pub. Date: Feb. 11, 2010

(54) GATE LATCH DEVICE

(75) Inventor: Edward Taglianetti, Staten Island, NY (US)

Correspondence Address: HOFFMANN & BARON, LLP, 6900 JERICHO TURNPIKE, SYOSSET, NY, 11791, US

(73) Assignee: FENCE WAREHOUSE, Staten Island, NY (US)

(21) Appl. No.: 12/506,818

(22) Filed: Jul. 21, 2009

Related U.S. Application Data
(60) Provisional application No. 61/082,387, filed on Jul. 21, 2008.

(51) Int. Cl. E05C 3/06

(52) U.S. Cl. 292/217; 292/216

(57) ABSTRACT

The embodiments of the present invention include a gate latching device having a first unit and a second unit configured to be operatively coupled by a shaft. The first unit can include a first locking mechanism and a latching mechanism that includes a latch and second unit can include a second locking mechanism, and a latch displacement mechanism. One of the first and second locking mechanisms is a key-actuated lock and the other is a keyless lock. The locking mechanism having a keyless lock may further include a latch displacement inhibitor to provide a multiple step operation to unlock the keyless lock to prevent operation by a child. The latch displacement mechanism can be operated to open the latch. The operation of the latch displacement mechanism can be prevented if the latch is locked and/or if it is being inhibited by the latch displacement inhibitor having an inhibit position and an uninhibited position. When the latch displacement inhibitor is in the inhibit position, the latch displacement inhibitor prevents the latch displacement mechanism from urging the latch towards the open position.

This application claims priority to U.S. Provisional Application No. 61/082,387 filed on Jul. 21, 2008, which is incorporated by reference herein in its entirety for all purposes.

### BACKGROUND

Lockable gate latches can be used for selectively securing a gate, door, or other similar structure, in a closed position. Conventional gate latches generally include two units, the first of which typically includes a latching mechanism and a key actuated lock, and the second of which typically includes a button for unlatching the gate and a key actuated lock. The first and second units are generally mounted on opposing sides of the gate. A striker bar is generally mounted on a post or other portion of the gate that is laterally adjacent to the gate when the gate is closed such that when the gate is closed the latching mechanism interfaces with and retains the striker bar to secure the gate in the closed position. Such gate latches can automatically latch when the gate or door is closed as a result of gravity and/or as a result of a biasing mechanism, such as a spring, and can be unlatched by overcoming gravity and/or the biasing mechanism.

These conventional gate latches can be used as security devices to prevent access to an area protected by the gate and can prevent, egress from the area protected by the gate using a key actuated lock on both units. However, these conventional gate latches can be burdensome to a user by requiring the user to use a key to unlock the gate from either side. Accordingly, a gate latch that provides security and a safety mechanism without the burdens of conventional gate latches is desired.

### SUMMARY OF THE INVENTION

The embodiments of the present invention include a gate latching device having a first unit and a second unit configured to be mounted on opposing sides of a fence structure and to be operatively connected via a shaft. The first unit includes a latching mechanism having a latch moveable between a closed position and an open position and a first locking mechanism to selectively lock the latch in the closed position. The second unit includes a latch displacement mechanism to displace the shaft along its longitudinal axis to urge the latch towards the open position. In some embodiments, the latch displacement mechanism comprises a push-button. The second unit includes a second locking mechanism operatively connected to the latching mechanism, wherein one of the first and second locking mechanisms is a key-actuated lock and the other is a keyless lock. Alternatively, both locking mechanisms may be keyless.

The second unit can include a latch displacement inhibitor that has an inhibit position and an uninhibited position. The latch displacement mechanism is inoperable when the latch displacement inhibitor is in the inhibit position. In some embodiments, the latch displacement inhibitor includes a rotatable knob disposed on an exterior portion of the second unit and an arm disposed within the second unit. The knob is operatively connected to the arm and is rotatable to position the arm in the inhibit position and the uninhibited position. The arm prevents the push button from being depressed when in the inhibit position. The arm can abut the push button in the inhibit position.

In some embodiments, the inhibitor includes at least one deflectable tab, which, when pressed inwardly, permits operation of the keyless lock to operate the latch displacement mechanism. The at least one deflectable tab can be disposed on a push-button of the latch displacement mechanism such that the push-button is inoperable until the deflectable tab is urged inwardly. The push-button can include the keyless lock having a rotatable knob to prevent operation of the push-button when in a locked position and allow operation of the push-button when in an unlocked position. The rotatable knob extends outwardly from a push-button housing. The knob is rotatable between a locked position, which prevents operation of the push-button, and an unlocked position, which allows operation of the push-button to operate the latch displacement mechanism. The push button of the latch displacement mechanism can be operatively connected to the shaft to displace the shaft along its longitudinal axis when the push button is depressed. The keyless lock can be disposed on the push button and can be operatively coupled to the shaft to rotate the shaft to lock and unlock the latch.

In some embodiments, the keyless lock is child-resistant and can require at least a two-step operation to unlock the latch displacement mechanism. The two-step operation can include activation of the inhibitor and unlocking of the latch to enable the latch displacement mechanism to be operated. In some embodiments, the latch is moveable to the open position using the first unit when the latch is unlocked and is not moveable to the open position using the second unit when the latch is unlocked and the inhibitor is in the inhibit position.

The embodiments of the present invention include a latch device for use with a gate. The latch device has a front unit and a rear unit adapted to be mounted on opposite sides of a structure associated with the gate and against which the gate closes. The front unit has a first housing adapted to be mounted on the structure, a manually displaceable latching tongue displaceably mounted in the first housing and adapted to interengage with a striker bar mounted on the gate and for holding the striker bar in a closed position to prevent opening the gate, a locking element displaceably mounted in the housing for locking the tongue when in a locked position and displaceable to a retracted position in which the tongue is released, and a front lock. The rear unit has a second housing including a rear lock and a displaceable actuator. The latch device also includes a latch displacement mechanism operable on activation of either the front lock or rear lock to displace the tongue between its locked and retracted positions. The latch displacement mechanism is operable when the front lock or the rear lock is in an unlocked position to permit the displaceable actuator of the rear unit to displace the tongue and release the striker bar. At least one of the front lock, the rear lock or both includes a keyless lock which requires at least two steps to unlock.

In some embodiments, the keyless lock comprises a push-button actuator having a first knob rotatable to a locked position and an unlocked position. The rear unit can further include a second rotatable knob mounted on a side portion of the second housing such that operation of the push-button in an unlocked position is prevented by the second rotatable knob when in an inhibit position and operable when in an uninhibited position. The latch is moveable to the open position using the first unit when the latch is unlocked and is not moveable to the open position using the second unit when the latch is unlocked and the inhibitor is in the inhibit position. In one embodiment, the front lock is a key-actuated lock and the rear lock is a keyless lock.

The embodiments of the present invention also include a method of operating a gate latch which includes a first unit mounted on one side of a gate and including a first locking mechanism and a second unit mounted on an opposite side of the gate and including a second locking mechanism. One of the first and second locking mechanisms is a key-actuated lock and the other is a keyless lock. Each of the first and second locking mechanisms are configured to lock and unlock the gate latch. The method includes using a key in the key-actuated lock to lock the latch to prevent it from being opened and operating the keyless lock to unlock the latch and permit the latch to be opened.

The above and other aspects of the present invention will become apparent upon consideration of the following detailed description of embodiments thereof, particularly when taken in conjunction with the accompanying drawings wherein like reference numerals in the various figures are utilized to designate like components.

### BRIEF DESCRIPTION OF DRAWINGS

FIG. 1A depicts a perspective view of a gate latching device in accordance with an embodiment of the present invention.

FIG. 1B depicts a latching and locking unit interfacing with a striker bar.

FIG. 2 depicts a perspective view of one embodiment of a locking and unlatching unit of the latch device.

FIG. 3 depicts a perspective view of the gate latching device with its housing removed to illustrate the internal mechanisms of the gate latching device.

FIGS. 4A-B depict a cross-sectional view of one embodiment of a locking and unlatching unit of the latch device.

FIGS. 5 and 6A-B depict an alternative embodiment of a locking and unlatching unit of the gate latching device.

FIG. 7A-B depict another embodiment of a latch displacement inhibitor.

FIGS. 8A-B depict yet another embodiment of a latch displacement inhibitor in a locking and unlatching unit.

FIGS. 9A-B depict a cross-sectional view of the unit of FIGS. 8A-B.

FIGS. 10A-B depicts another configuration of the latch displacement inhibitor.

### DETAILED DESCRIPTION OF THE EMBODIMENTS

The embodiments of the present invention include a gate latching device having a first unit and a second unit that can be mounted on opposing sides of a gate, door, or like structure, for selectively securing the gate, door, or like structure, in a closed and/or locked position. The first unit can include a first locking mechanism and a latching mechanism that includes a latch and second unit can include a second locking mechanism, a latch displacement mechanism, and a latch displacement inhibitor.

The latch displacement mechanism can be used to urge the latch towards the open position. The operation of the latch displacement mechanism can be prevented if the latch is locked and/or if it is being inhibited by the latch displacement inhibitor.

The latch displacement inhibitor can have an inhibit position and an uninhibited position. When the latch displacement inhibitor is in the inhibit position, the latch displacement inhibitor prevents the latch displacement mechanism from urging the latch towards the open position. To displace the latch using the latch displacement mechanism, the latch displacement inhibitor is adjusted to the uninhibited position and the latch is unlocked. In this way, the gate latch requires a two-step operation to unlatch the gate latch, wherein the gate latch must be unlocked and the latch displacement inhibitor must be in the uninhibited position to provide a safety feature.

The embodiments of the present invention advantageously allow a user to selectively position and lock the latch in a closed position, and allow the user to unlock and selectively position the latch in the open position. The locking of the latch can be accomplished by providing, for example, a key-actuated lock on a first unit and a keyless lock on the second unit. Alternatively, the lock arrangement may be modified so that the keyless lock is provided on the first unit and a key-actuated lock is provided on the second unit. The embodiments can advantageously reduce the burden of unlocking and unlatching the latch using the second unit. As a further feature, the keyless lock may include additional safety features to prevent, for example, children from moving the latch to an open position to allow the gate, door, or like structure, to be opened. This can be achieved using the latch displacement mechanism and the latch displacement inhibitor of the second unit.

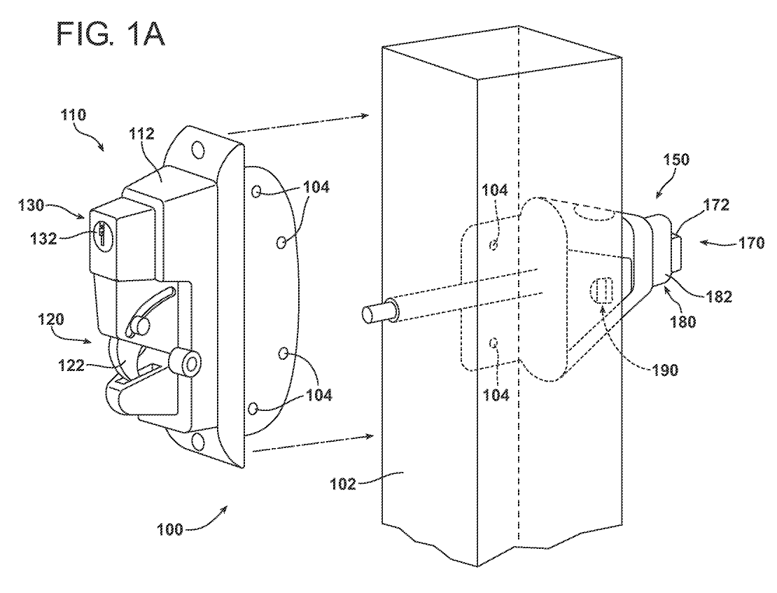

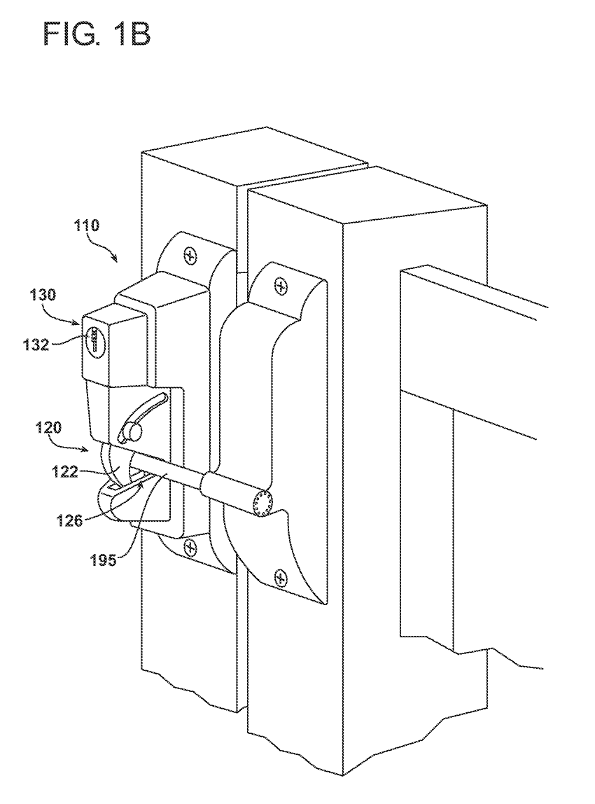

FIG. 1 depicts an exemplary embodiment of a gate latch 100 having a locking and latching unit 110 (hereinafter “unit 110”) and a locking and unlatching unit 150 (hereinafter “unit 150”), which can have housings 112 and 152, respectively, formed of plastic, metal, or other suitable materials. The units 110 and 150 can be mounted on a structure 102, such as a fence, fence post, gate, gate post, door, or other similar structure, with fastening mechanisms 104, such as screws, nails, adhesive, and the like, so that the first and second units 110 and 150 are operatively connected as discussed below and have an opposing relation.

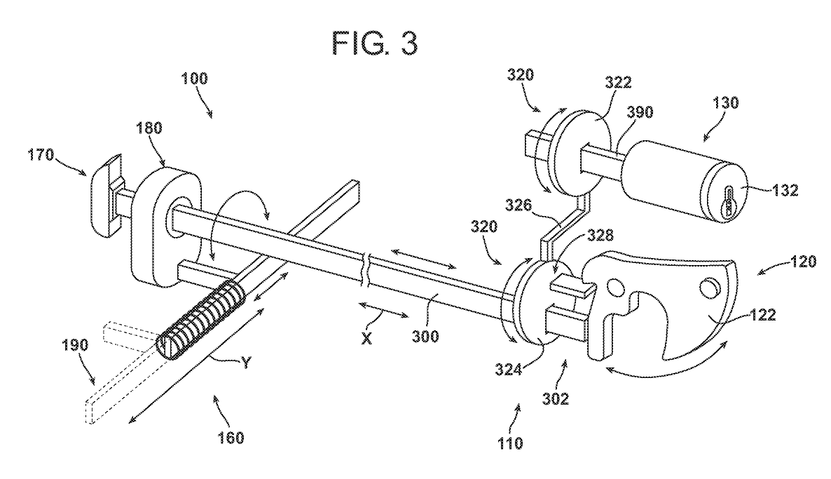

The unit 110 can include a latching mechanism 120 and a first locking mechanism 130, such as a key-actuated lock or a keyless lock, such as a turn knob actuated lock, button actuated lock, lever actuated lock, or the like, as well as an internal locking structure (FIG. 3) for operatively connecting the first locking mechanism 130 to the latching mechanism 120 to facilitate locking of the latching mechanism 120. In the present embodiment the first locking mechanism is a key actuated lock 132. The unit 110 can be configured so that the latching mechanism 120 interfaces with and retains a striker bar 195 (FIG. 1B) to selectively hold the structure 102 in a closed position. The first locking mechanism 130 can be used to selectively lock the structure 102 in the closed position by fixedly securing the latching mechanism 120 in closed position about the striker bar 195.

The latching mechanism 120 can include a latch 122 which is disposed within the housing 112 and is rotatably fixed at a pivot joint 124. The latch 122 can have a center of gravity offset towards the front so that the latch 122 falls under its own weight to adopt the closed position. A notched or recessed section 126 can be formed in the housing 112 for receiving the striker bar 195. When the latch is in the closed position a portion of the latch 122, referred to herein as the latching tongue, extends into and through the recessed section 126 of the housing 112 so that the latch 122 can capture and retain the striker bar 195 in the recessed section 126. When the latch 122 is in an open position, the latch 122 retracts into the housing 112. The exposed portion of the latch 122 in the closed position, referred to herein as the latching tongue, can have a generally convexly curved outer portion and a generally concavely curved inner portion so that the exposed portion of the latch 122 has a generally crescent shaped configuration. When the latching mechanism is unlocked, the latch 122 can be moved along a curved slot 128 being radially positioned about the pivot joint 124. The latch 122 can be displaced along the slot 128 by manually urging the latch 122 using a manual positioning member 130 disposed thereon; deflecting the latch 122 along the slot 128 upon the outer portion of the latch 122 contacting the striker bar 195 with sufficient force to admit the pin into the recess section 126; and/or by other mechanisms, such as those mechanisms discussed below.

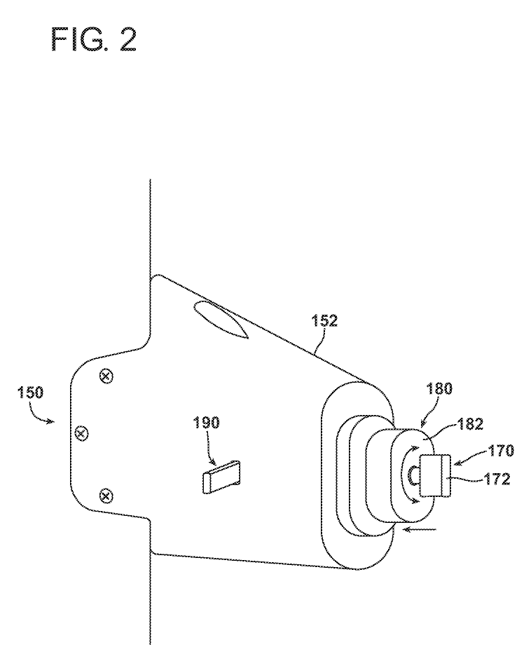

Referring to FIGS. 1A and 2, the unit 150 can include a second locking mechanism 170, such as a key actuated lock or a keyless lock, such as a turn knob actuated lock, button actuated lock, lever actuated lock, or the like, and a latch displacement mechanism 180. Advantageously, the locking mechanism 170 can include a latch displacement inhibitor 190 to provide a further safety feature. In the present embodiment, the second locking mechanism is a keyless turn knob actuated lock 172 (hereinafter “knob 172”).

The locking mechanism 170 functions to lock the latch 122 in the closed position by rotating the knob 172 to a locked position. When the locking mechanism 170 is in the locked position, the latch 122 is fixedly secured in the closed position. The latch displacement mechanism 180 can be activated to urge the latch 122 to the open position when the latch 122 is not locked, for example, by pushing a push button 182 of the latch displacement mechanism 180 inwardly into the housing 152. The latch displacement inhibitor 190 can prevent the latch displacement mechanism 180 from urging the latch 122 towards the open position. As result, when the latch is not locked, a user can move the latch 122 to the open position by activating the inhibitor 190 to remove the inhibition provided by the latch displacement inhibitor 190 and by acting upon the latch displacement mechanism 180 of the unit 160. In this way, the operation of the keyless lock requires a two-step operation to unlatch a gate latch of unit 110, wherein the gate latch must be unlocked and the latch displacement inhibitor must be in the uninhibited position to provide a child resistant keyless lock. When the latch is unlocked, the latch is moveable to the open position using the manual positioning member 130 of the unit 110, but is not moveable to the open position using the second unit until the inhibitor is moved to the uninhibited position despite the latch being unlocked.

FIG. 3 depicts one embodiment of the gate latch 100 without the housings 112 and 152, and the structure 102 to illustrate the operation of gate latch 100. A shaft 300 extends between the units 110 and 160 to operatively connect the units 110 and 160. The shaft 300 can engage the second locking mechanism 170 of the unit 160 and can engage and extend through a locking structure 320 so that a distal end 302 of the shaft 300 is positioned in proximity to the latch 122.

The locking structure 320 can include rotating members 322 and 324, where the rotating members 322 and 324 are operatively coupled by a translational shaft 326. The rotating member 322 can be operatively connected to a shaft 390 extending from the first locking mechanism 130, which can rotate according to the rotation of the key actuated lock 132. In response to the rotation of the shaft 390, the member 322 rotates, the rotation of which is transmitted to the member 324 by the translational shaft 326 so that the member 324 rotates in an opposite direction as that of the member 322. The member 324 can have a protrusion 328 formed thereon that can be positioned according to the rotational position of the members 322 and 324. The protrusion 328 can be positioned with respect to the latch such that the latch is fixedly secured in the locked position by the protrusion 328.

A proximate end 304 of the latch 122 can include a ridge 392 that can abut the protrusion 328 when the locking structure is in the locked position to prevent the latch 122 from rotating about pivot joint 124. To unlock the latching mechanism 120, the members 322 and 324 are rotated so that the protrusion 328 rotates away from the ridge 392 to allow the latch 122 to move between the open and closed position.

The shaft 300 can be operatively coupled to the member 324 such that when one of the shaft 300 or the member 324 rotate, the other rotates as well, allowing both the front and rear units 110 and 160 to lock and unlock the latch 122. In one embodiment, the member 324 has an opening through which the shaft 300 can extend. The shaft 300 can also be movably positioned along its longitudinal axis X using the latch displacement mechanism 180. When the latch 122 in the unlocked closed position and the shaft 300 is urged forward by the latch displacement mechanism 180, the distal end 302 of the shaft 300 abuts against the proximate end 304 of the latch 122 urging the latch 122 to rotate about the pivot joint 124 towards the open position. The ability to displace the latch 122 using the unit 150 can be dependent on whether the latch is locked and whether the latch displacement inhibitor 190 is inhibiting the operation of the latch displacement mechanism 180 by preventing the latch displacement mechanism 180 from displacing the latch 122.

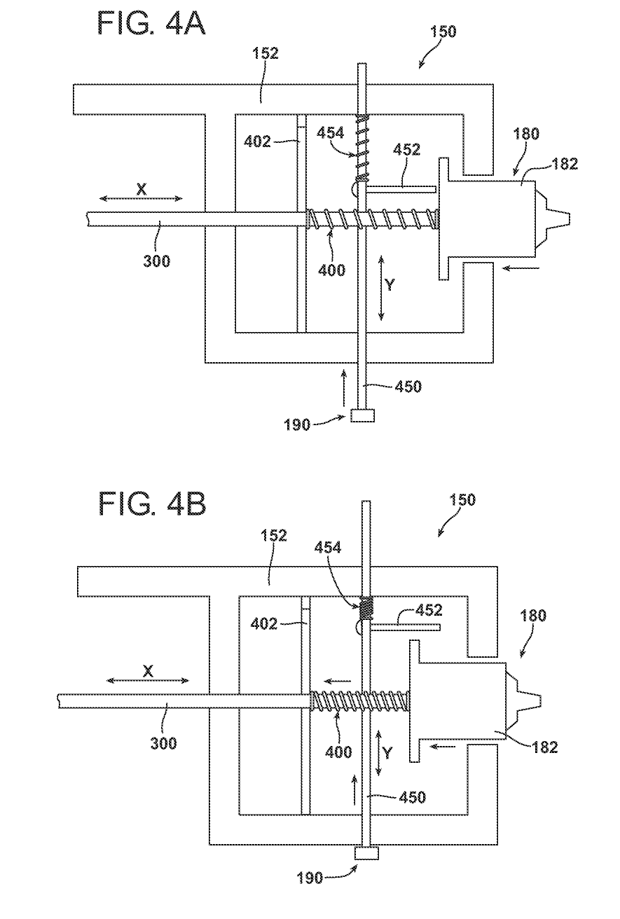

Referring to FIGS. 3 and 4A-B, latch displacement mechanism 180 can include a push button 182 operatively coupled to the shaft 300, which can move between an extended position (FIG. 4A) and a retracted position (FIG. 4B). A resilient member 400, such as a steel spring, can be used to bias the push button in the extended position by default such that the latch 122 is not displaced by the shaft 300. The resilient member 400 can extend from the push button to a support structure 402, which can be a wall of, or within, the housing 152 or can be another suitable structure, so that the resilient member provides a sufficient force to hold the push button 182 in the extended position, but that can be overcome when a user desires to depress the push button 182 to open the latch 122 (FIGS. 4A-B). In the present embodiment, the resilient member 400 is disposed about and along a portion of the shaft 300 between the push button 182 and the support structure 402, although those skilled in the art will recognize that the resilient member 400 can be implemented using different configurations.

The latch displacement inhibitor 190 can include a rod member 450 that can extend through opposing sides of the housing 152 and that is movably configured to slide along its longitudinal axis Y between an inhibit position (FIG. 4A) and an uninhibited position (FIG. 4B). In the present embodiment, the rod member 450 extends through the side walls of the housing and is configured to have a generally orthogonal relation to the shaft 300. An inhibit member 452 can be disposed on the rod member 450 and can extend from the rod member 450 towards the push button 182 to engage the push button 182. The inhibit member 452 can inhibit the depression of the push button 182 when the rod member 450 is in the inhibit position. The inhibit member 452 can extend from the rod member 450 in a generally orthogonal direction. The rod member 450 and the inhibit member 452 can be formed from a single piece of material or can be joined together by, for example, a weld, adhesive, a screw, a nut and bolt, or the like. When the rod member 450 is slid into the uninhibited position, the inhibit member 452 is displaced so that it no longer abuts the push button 182; thereby allowing a user to depress the push button to urge the latch 122 towards the open position.

The latch displacement inhibitor 190 can include a resilient member 454, such as a steel spring. The resilient member 454 can be disposed about the rod member 450 an can extend along the rod member 450 between a support structure, such as a wall of, or within, the housing 152 and the location on the rod member at which the inhibit member 452 protrudes or another suitable location. The resilient member 452 can bias the latch displacement inhibitor 190 in the inhibit position to prevent the depression of the push button 182 by aligning the inhibit member 452 with at least a portion of the push button 182 so that when the user attempts to depress the push button 182, at least a portion of the push button 182 abuts against the inhibit member 452. The resilient member 454 provides a sufficient force to hold the latch displacement inhibitor 190 in the inhibit position, but can be overcome when a user desires to depress the push button 182 without being inhibited. Once the push button 182 returns to its extended position after being depressed the rod member 450 can slide, due to the force exerted by the resilient member 454, back to the inhibit position.

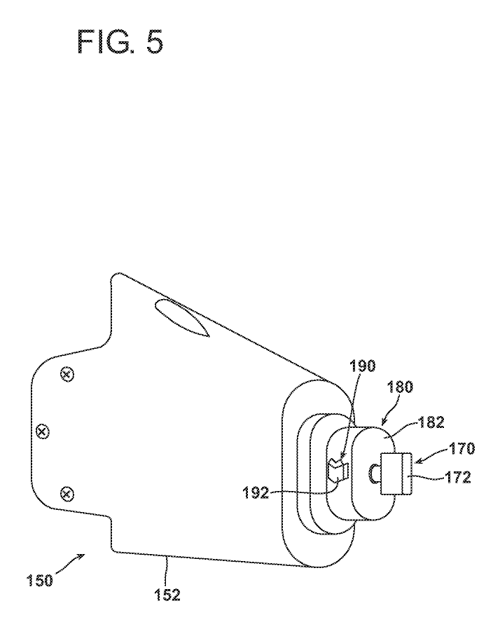

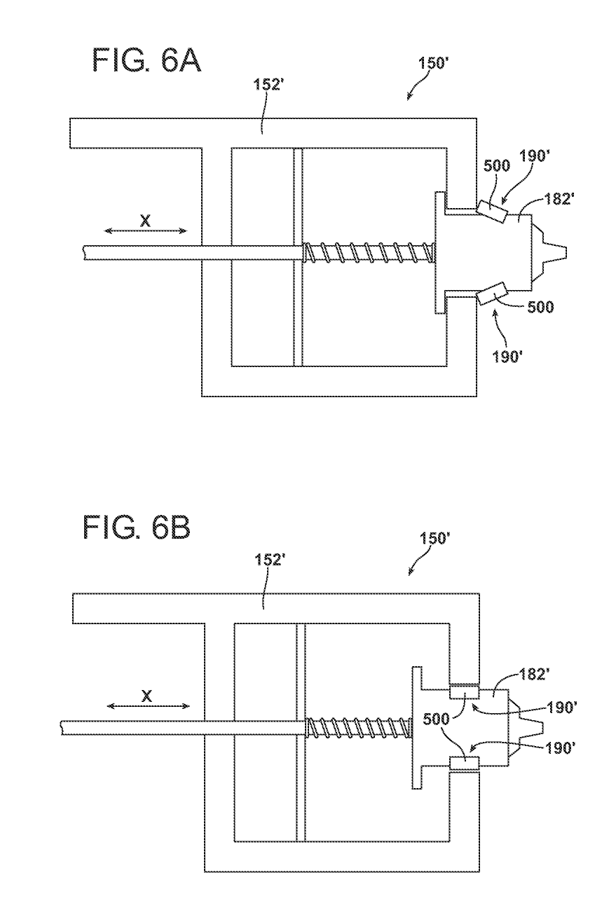

FIGS. 5 and 6A-B show another embodiment of the latch displacement inhibitor 190′ associated with unit 150′. In the present embodiment, the latch displacement inhibitor 190′ can include one or more deflectable tabs 500 formed on the push button 182′. The tabs 500 can be formed continuously with the push button 182′ or can be form from one or more separate pieces of material. The tabs 500 can be formed from a resilient or elastic material, such as plastic, rubber, metal, and the like. The tabs may extend outwardly from the body 500 of the push button 182′ to occupy the inhibit position so that the tabs 500 prevent the push button 182′ from being depressed into the housing 152′, and therefore, preventing the latch displacement mechanism 180′ from urging the latch towards the open position (FIG. 6A). The tabs 500 can be urged inwardly into the body of the push button 182′ to occupy an uninhibited position to allow the push button 182′ to be depressed into the housing 152′ resulting in the urging of the latch towards the open position (FIG. 6B).

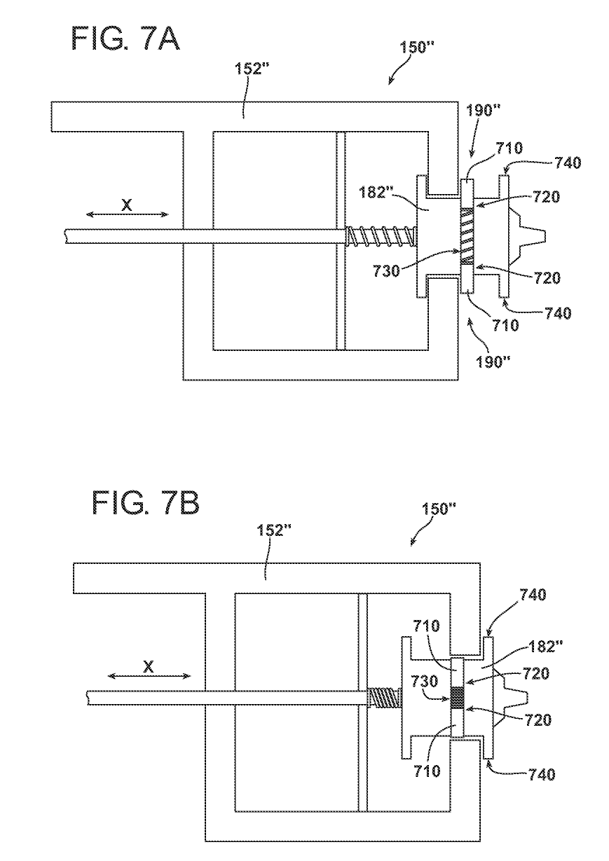

Those skilled in the art will recognize that other configurations and implementation of the gate latching device can be implemented. For example referring to FIG. 7A-B, the latch displacement inhibitor 190″ can include one or more tabs or studs 710 extending through openings in the side walls of the push button 182″. For example, two studs can be extend through opposing sides of the body of the push button 182″. Proximate ends 720 of the studs can be operatively coupled to each other via a resilient member 730, such as a steel spring. The steel spring can be biased to force the studs outwardly away from the sides walls of the push button 182″ to bias the latch displacement inhibitor 190″ in the inhibit position. The studs can be pushed towards each other overcoming the force exerted by the resilient member 730 so that the studs are now in the uninhibited position to allow the push button 182″ to be depressed into the housing 152″. The push button 182″ can include blocks 740 that prevent the push button 182″ from being depressed too far so that the studs 710 remain in the uninhibited position by engaging the housing wall; thereby preventing the push button from getting stuck in the depressed position.

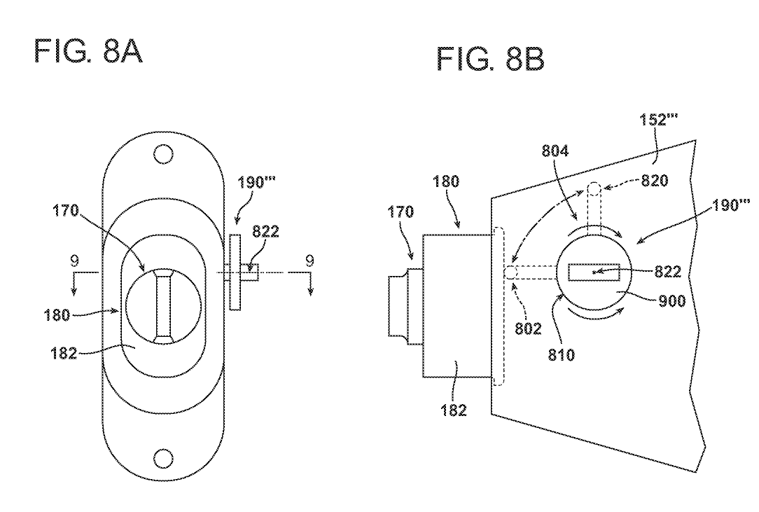

FIGS. 8A-B depict a locking and unlatching unit 150′″ (hereinafter unit 150′″) having the locking mechanism 170, the latch displacement mechanism 180, and a latch displacement inhibitor 190′″. FIG. 8A depicts a front view of the unit 150′″ and FIG. 8B depicts a side view of the unit 150′″. The latch displacement inhibitor 190′″ includes a turn knob 810 having a circular portion 812 disposed on a side portion of the exterior of the housing 152′″. The housing 152′″ can include a legend for identifying the inhibited (“lock”) and uninhibited (“open”) positions as well as for identifying a direction in which the turn knob should be rotated to move the inhibitor into an inhibit position 802 and an uninhibited position 804.

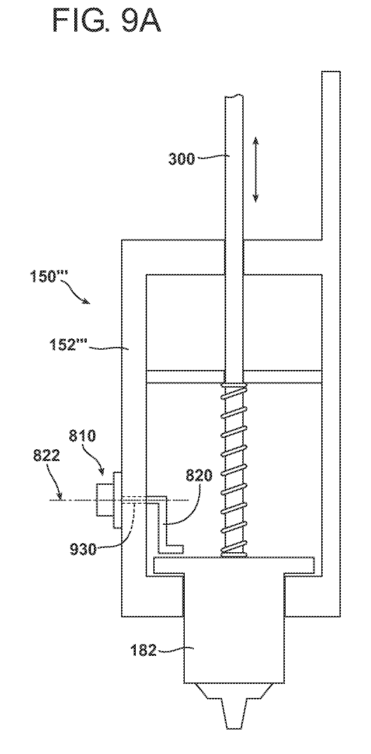

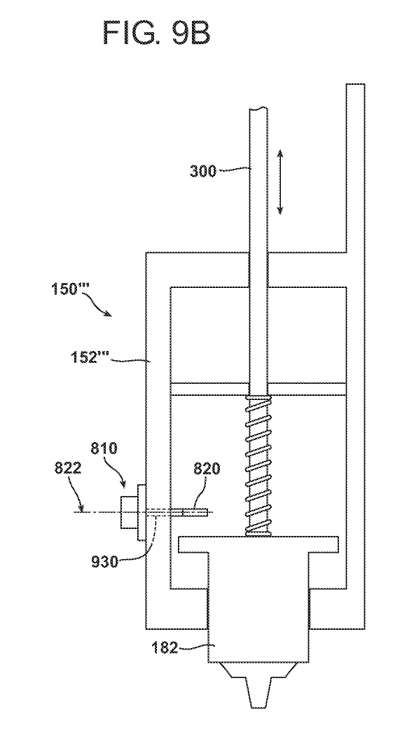

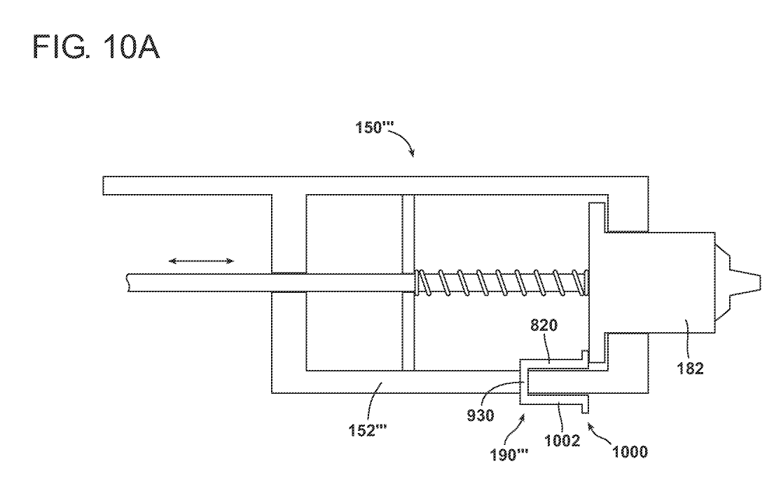

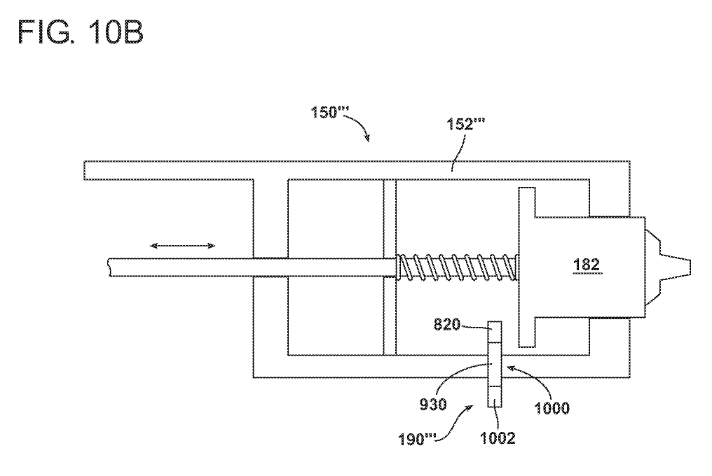

The turn knob 810 can be rotated about its center axis 822. The inhibitor 190′″ also includes an internal arm 820 operatively connected to the turn knob via a connecting member (FIG. 9). The internal arm 820 extends radially from the center axis 822 so that when the turn knob 810 is rotated, the rotation is translated to the internal arm 820 which rotates about the center axis 822, away from or towards the push button 182. Thus, the internal arm 820 can be rotated between the inhibit or locked position 802 and the uninhibited or open position 804. In this way, the operation of the keyless lock requires a two-step operation to unlatch a gate latch of unit 110 (FIGS. 1A, 1B, and 10). To open the latch, the keyless lock must be unlocked and the latch displacement inhibitor must be in the uninhibited position to allow the push button to be operated thereby providing a child safety feature. When the latch is unlocked, the latch is moveable to the open position using the manual positioning member 130 of the unit 110, but is not moveable to the open position using the second unit until the inhibitor is moved to the uninhibited position despite the latch being unlocked.

FIGS. 9A and 9B show a cross-sectional view of the unit 150′″ along line 9-9 of FIG. 8A. In the inhibit position (FIG. 9A), the internal arm 820 extends from the connecting member 930 through the housing 152′″ and connects the internal arm to the turn knob 810 and abuts the push button 182 of the latch displacement mechanism 180 to prevent the latch displacement mechanism from displacing the shaft 300 along its longitudinal axis and urging the latch towards the open position. In the uninhibited position (FIG. 9B), the turn knob 810 can be rotated clockwise or counter clockwise to rotate the internal arm 820 about the center axis 822 and away from the push button 182 so that the internal arm 820 no longer abuts the push button 182 and the push button 182 can be depressed to displace the shaft 300 and urge the latch towards the open position. The push button 182 can be biased by the resilient member 400 so that the push button is in the extended position by default and the latch is not displaced by the shaft 300. The resilient member 400 biasing the push button can be overcome when a user desires to depress the push button 182 thereby opening the latch of the unit 110 (FIGS. 1A, 1B, and 3).

While the turn knob is depicted having a circular tab portion, one skilled in the art will recognize that other configurations may be implemented. For example, referring to FIGS. 10A-B, the locking and unlatching unit 150′″ (hereinafter unit 150′″) can have a turn knob 1000 with an external arm 1002 outside the housing 152′″. The external arm 1002 may be connected to the internal arm 820 inside the housing 152′″ via a connecting member 930. In this embodiment, the external arm 1002, connecting member 930, and internal arm 820 can have a generally U-shaped configuration. Accordingly, the keyless lock may be made child-resistant by requiring a two-step operation to permit the push button to be operated.

While embodiments of the present invention have been described herein, it is expressly noted that the present invention is not limited to these embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made explicit herein, without departing from the spirit and scope of the invention.

What is claimed is:

1. A gate latching device comprising:
a first and second unit configured to be mounted on opposing sides of a fence structure and to be operatively connected via a shaft, the first unit including a latching mechanism having a latch moveable between a closed position and an open position and a first locking mechanism to selectively lock the latch in the closed position, the second unit including a latch displacement mechanism for displacing the shaft along its longitudinal axis to urge the latch towards the open position and including a second locking mechanism operatively connected to the latching mechanism, wherein one of the first and second locking mechanisms is a key-actuated lock and the other is a keyless lock.

2. The gate latching device of claim 1, wherein the second unit comprises a latch displacement inhibitor having an inhibit position and an uninhibited position, the latch displacement mechanism being inoperable when the latch displacement inhibitor is in the inhibit position.

3. The gate latching device of claim 2, wherein the latch displacement mechanism includes a push button operatively connected to the shaft to displace the shaft along its longitudinal axis when the push button is depressed, the keyless lock being disposed on the push button and being operatively coupled to the shaft to rotate the shaft to lock and unlock the latch.

4. The gate latching device of claim 3, wherein the latch displacement inhibitor includes a rotatable knob disposed on an exterior portion of the second unit and an arm disposed within the second unit, the knob being operatively connected to the arm and being rotatable to position the arm in the inhibit position and the uninhibited position, the arm preventing the push button from being depressed when in the inhibit position.

5. The gate latching device of claim 4, wherein the arm abuts the push button in the inhibit position.

6. The gate latching device of claim 1, wherein the keyless lock is child-resistant.

7. The gate latching device of claim 6, wherein the child-resistant keyless lock requires at least a two-step operation to unlock the latch displacement mechanism.

8. The gate latching device of claim 7, wherein the keyless lock includes an inhibitor having an inhibit position and an uninhibited position, the latch displacement mechanism being inoperable when the inhibitor is in the inhibit position.

9. The gate latching device of claim 8, wherein the two-step operation includes actuation of the inhibitor and unlocking of the latch to enable the latch displacement mechanism to be operated.

10. The gate latching device of claim 7, wherein the inhibitor comprises at least one deflectable tab, which, when pressed inwardly, permits operation of the push button to operate the latch displacement mechanism.

11. The gate latching device of claim 7, wherein the inhibitor comprises a spring biased rod.

12. The gate latching device of claim 3, wherein the push button includes at least one deflectable tab such that the push button is inoperable until a deflectable tab disposed on the push button is urged inwardly.

13. The gate latching device of claim 3, wherein the push button includes a keyless lock having a knob to prevent operation of the push-button when in a locked position and allows operation of the push button when in an unlocked position.

14. The gate latching device of claim 1, further comprising a rotatable knob extending outwardly from a push button housing, the knob being rotatable between a locked position which prevents operation of the push-button and an unlocked position which allows operation of the push button to operate the latch displacement mechanism.

15. The gate latching device of claim 2, wherein the latch is moveable to the open position using the first unit when the latch is unlocked and is not moveable to the open position using the second unit when the latch is unlocked and the inhibitor is in the inhibit position.

16. A latch device for use with a gate comprising:
a front unit and a rear unit adapted to be mounted on opposite sides of a structure associated with the gate and against which the gate closes;
the front unit having a first housing adapted to be mounted on the structure, a manually displaceable latching tongue displaceably mounted in the first housing and adapted to interengage with a striker bar mounted on the gate and for holding the striker bar in a closed position to prevent opening the gate, a locking element displaceably mounted in the housing for locking the tongue when in a locked position and displaceable to a retracted position in which the tongue is released, and a front lock;
the rear unit having a second housing including a rear lock and a displaceable actuator;
a latch displacement mechanism operable on activation of either the front lock or rear lock to displace the tongue between its locked and retracted positions and operable when the front lock or the rear lock is in an unlocked position to permit the displaceable actuator of the rear unit to displace the tongue and release the striker bar, wherein at least one of the front lock, the rear lock or both comprises a keyless lock which requires at least two steps to unlock.

17. A latch device of claim 16, wherein the keyless lock comprises a push button actuator having a first knob rotatable to a locked position and an unlocked position, the rear unit further including a second rotatable knob mounted on a side portion of the second housing such that operation of the push-button in unlocked position is prevented by the second rotatable knob when in an inhibit position and operable when in an uninhibited position.

18. The gate latching device of claim 17, wherein the latch is moveable to the open position using the first unit when the latch is unlocked and is not moveable to the open position using the second unit when the latch is unlocked and the inhibitor is in the inhibit position.

19. A latch device of claim 16, wherein the front lock is a key-actuated lock and the rear lock is a keyless lock.

20. A method of operating a gate latch which includes a first unit mounted on one side of a gate and including a first locking mechanism and a second unit mounted on an opposite side of the gate and including a second locking mechanism, wherein one of the first and second locking mechanisms is a key-actuated lock and the other is a keyless lock each configured to lock and unlock the gate latch comprising the steps of:
using a key in the key-actuated lock to lock the latch to prevent it from being opened; and
operating the keyless lock to unlock the latch and permit the latch to be opened.
